(19) United States
(12) Patent Application Publication
(10) Pub. No.: US 2008/0305219 A1
(43) Pub. Date: Dec. 11, 2008

(54) COATED EDIBLE SUBSTRATE AND RELATED METHODS

(76) Inventor: Douglas Stewart, Arden, NC (US)

Correspondence Address: MORSE, BARNES-BROWN & PENDLETON, P.C.;ATTN: PATENT MANAGER, RESERVOIR PLACE, 1601 TRAPELO ROAD, SUITE 205, WALTHAM, MA, 02451, US

(21) Appl. No.: 12/191,889

(22) Filed: Aug. 14, 2008

(51) Int. Cl. A23G 3/54

(52) U.S. Cl. 426/103; 426/104; 426/289; 426/383

(57) ABSTRACT

The invention provides an edible substrate, e.g., an edible decorative sheet material, having improved moisture stability. In particular, the invention relates to an edible substrate having improved tolerance to a range of high and low humidity conditions. In one embodiment the invention relates to a composition comprising an edible substrate coated over a substantial portion of one or more surfaces with at least one edible moisture barrier and to methods of making and using the improved edible substrate.

### BACKGROUND OF THE INVENTION

There is currently a market for edible substrates, such as printed edible sheet material, for use as an edible food embellishment. The printed, sheeted edible base material is generally produced on a carrier-type release media (typically a poly or silicone coated paper) and is subsequently peeled and applied to the surface of a food product, such as an “iced” or frosted cake, cookie, cupcake or the like, to effect decoration. The edible sheet material has a great propensity to give up moisture in low moisture environments and to absorb moisture from high moisture environments. Accordingly, the edible media absorbs moisture from the icing and becomes easy to cut and eat with the cake. The sheeted edible base material is typically starch-based with a variety of other constituents to affect functionalities such as flexibility, moisture retention, extended shelf life, and so on.

The edible sheet material market is typically divided into two product segments, pre-printed and print-on-demand. The pre-printed market is usually printed primarily using edible pigmented inks, with water soluble dyes incorporated to extend the typically limited color gamut of pigmented lakes in an ink application. Typically the printing process is a silk screen or, to a much lesser extent, pad printing.

The substrate and printed images are sensitive to destruction by moisture and exposure to UV light. Moisture may attack from beneath (e.g., high moisture content icings on which the image lays) and from extreme ambient conditions such as high humidity or condensation forming on the surface of the food product due to defrosting. Plastic domes that cover the food product hold extreme moisture inside, creating a challenge to the integrity of any printed edible image. Bleeding, feathering, and blotching are all associated with the failure of an image.

The print-on-demand market utilizes blank, unprinted, sheets or substrates of edible material, edible inks in ink jet form, and the equipment associated with producing the graphic image on the edible substrate (e.g., printers, computers, scanners, copiers and the like). Currently all edible inks used in the print-on-demand market are produced using edible FD&C dyes, not pigments. Ink jet technology cannot, as yet, accommodate the particle size and inconsistency of an edible ink produced with edible pigment lakes. Consequently, these printed images are typically even more susceptible to damage from UV sources and the introduction of moisture due to the highly soluble nature of edible dyes.

If a printed or un-printed sheet of the edible material becomes too dry before being applied to the food product, it becomes brittle and inflexible, cracks, and cannot be peeled intact from the backing sheet and subsequently applied by the end user. On the other hand, if a printed or un-printed sheet of the edible material becomes too moist, it becomes tacky, wet, and will not release from the carrier sheet, rendering it useless as well. In addition, the image may feather, bleed or become blotchy.

Partly as a result of these limitations, the vast majority of pre-printed products available for use to decorate food products are not available as retail items. When they are available they are most typically packaged in metallized (usually foil-type) pouches to provide a moisture and oxygen barrier. This packaging is unattractive to consumers (the consumer cannot see the contents) but is important to minimize destruction of the edible sheet or image resulting from moisture, dryness, oxygen and UV light. In addition, the metallized pouch (or other type of packaging offering a significant oxygen and moisture barrier) and consequent full color label required to convey the contents are relatively expensive, and this cost is often passed along to the consumer. Thus, there has been very limited success and acceptance of the product in a retail setting for these reasons.

### SUMMARY OF THE INVENTION

The invention relates to a composition comprising an edible substrate coated over a substantial portion of one or more surfaces with an edible moisture barrier. The invention also relates to methods of making and using the improved edible substrates of the invention. Applicant has surprisingly found that significantly moisture sensitive edible substrates and edible images can nonetheless be beneficially treated with an edible fluid coating. Not only does such treatment not destroy the sensitive substrate or image, but the treatment in fact improves the moisture and oxygen stability of the substrate and image.

The invention provides an edible substrate, e.g., an edible sheet material, having improved properties. In particular embodiments, the invention relates to an edible substrate having improved moisture stability, i.e., tolerance to a range of high and low humidity conditions. In particular embodiments the improved edible substrate may also have improved resistance to the damaging effects of oxygen. In certain embodiments the improved edible substrate may have improved shelf life, particularly in extreme conditions. The improved edible substrate may also have a glossy surface appearance, resulting in altered visual appeal (images printed on the edible substrate may appear brighter, sharper and have improved color and clarity). The improved edible substrate may also have improved UV light resistance and/or improved light reflecting properties, as well as reduced fading and discoloration of images printed thereon. In other embodiments the improved edible substrate may have improved adherence to a carrier upon which it is deposited, for example, during the handling and packaging processes as well as during retail display timeframe where the retail product will typically be hung for display for varying lengths of time. The improved edible substrate may also have improved flexibility (i.e., can be flexed to a reasonable degree without cracking). The improved functionality of the edible substrate of the invention allows products incorporating the substrate to be packaged in simple, economical, clear packaging and may improve retail acceptance of these products. The improved edible substrate need not have all of the improved properties in the context of the invention.

In one embodiment the invention relates to a composition comprising an edible substrate coated over a substantial portion of one or more surfaces with an edible moisture barrier. In particular embodiments the edible substrate is a substrate suitable for having an edible image applied thereto or which has an edible image applied thereto. In other embodiments the edible substrate is sensitive to one or more of moisture, oxygen, and UV light. In particular aspects the edible substrate is not a pill or a candy. In one aspect the edible substrate is an edible paper, an edible sheet or an edible frosting sheet. In another aspect, the edible image on the edible substrate is printed with edible dye, edible pigment or both.

In some aspects of the invention, the edible substrate is completely coated over one or more surfaces with said edible moisture barrier; in other aspects only a portion of the edible substrate having an image or other embellishment applied thereon is coated with said edible moisture barrier. In some embodiments more than one coat or application of the edible moisture barrier is applied to the edible substrate, with subsequent applications covering the same or different area of the substrate as one or more prior applications. In embodiments utilizing more than one application of moisture barrier, subsequent applications can be performed with the same or different moisture barrier as prior applications.

In preferred embodiments the edible moisture barrier comprises a hydrophobic material, such as a hydrophobic protein material. In particular embodiments, the edible moisture barrier is selected from the group consisting of corn zein, wheat protein, soy protein, egg albumin, and whey protein. In other embodiments, the edible moisture barrier comprises a carbohydrate polymer, such as a cellulose, a starch, a dextrin, a pectin, an alginate, or combinations thereof. In particular embodiments the edible moisture barrier comprises carboxymethylcellulose, hydroxypropyl cellulose, or combinations thereof. In other aspects of the invention the edible moisture barrier comprises a solid lipid or wax, such as beeswax, carnuba wax or combinations thereof. In other embodiments the edible moisture barrier comprises an edible resin, such as an edible shellac or an edible shellac/oil combination. The invention also relates to aspects in which the edible moisture barrier comprises an emulsion of palmitic acid, gelatin, collagen or combinations thereof.

In some aspects of the invention the edible substrate further optionally comprises one or more plasticizers, glycerines, preservatives, additional embellishments (e.g., edible glitter, pearlescent edible mica) or combinations thereof.

The invention also relates to a food product embellished with a composition comprising an edible substrate coated over a substantial portion of its surface with an edible moisture barrier.

The invention further relates to a method of preparing a composition comprising an edible substrate coated over a substantial portion of its surface with an edible moisture barrier, said method comprising obtaining an edible substrate (e.g., an oxygen and/or moisture sensitive edible substrate); and applying an edible moisture barrier over a substantial portion of the surface of the edible substrate. Application of the edible moisture barrier may optionally be repeated one or more times, and subsequent applications may utilize the same or different edible moisture barriers as one or more prior applications and may cover the same or different areas of the substrate as prior applications. Moreover the edible moisture barrier may be applied to the front and/or back of the edible substrate during any application.

It should be clearly understood that there are many embodiments of the methods of the invention which will produce a coated and improved edible substrate according to the invention. A number of exemplary embodiments are specifically described herein, but others are contemplated within the scope of the invention. More particularly, the presence, absence and order of the steps of the methods described are variable as long as an edible substrate as described herein is coated over a substantial portion of one or more surfaces with an edible moisture barrier. It is immaterial whether the edible substrate used as the starting material is imaged or unimaged, embellished or unembellished. Moreover, one or more images and/or embellishments may be added to the substrate before or after application of an edible moisture barrier, and the described imaging, embellishment (including, e.g., imaging) and coating steps may repeated one or more times and interspersed in any way.

The invention also relates to a method of preparing a composition comprising an edible substrate coated over a substantial portion of its surface with an edible moisture barrier, said method comprising obtaining an edible substrate; applying an edible moisture barrier over a substantial portion of the surface of the edible substrate; applying one or more edible embellishments (e.g., images) to said substrate; and, optionally, repeating application of an edible moisture barrier one or more times. The coated substrate can optionally be further embellished as well.

The invention also relates to a method of preparing a composition comprising an edible substrate coated over a substantial portion of its surface with an edible moisture barrier, said method comprising obtaining an edible substrate; applying an edible embellishment (e.g., image) to said substrate; applying an edible moisture barrier over a substantial portion of the surface of the edible substrate; and, optionally, repeating application of an edible moisture barrier one or more times. The coated substrate can be further embellished as well.

The invention further relates to a method of preparing a composition comprising an edible substrate coated over a substantial portion of its surface with an edible moisture barrier, said method comprising obtaining an edible substrate having an image applied thereto; and applying an edible moisture barrier over a substantial portion of the surface of the edible substrate. The application of the edible moisture barrier can be optionally repeated one or more times with the same or different edible moisture barrier for each application. In some embodiments the edible moisture barrier is applied at least to the portion of the edible substrate to which the image is applied.

In other embodiments the portion of the edible substrate to which the image is not applied is excised from the portion of the substrate to which the image is applied and discarded prior to application of the edible moisture barrier.

The invention also relates to a method of preparing a composition comprising an edible substrate coated over a substantial portion of its surface with an edible moisture barrier, said method comprising obtaining an edible substrate; applying an edible image thereto; and applying an edible moisture barrier over a substantial portion of the surface of the edible substrate. In some embodiments the edible moisture barrier is applied at least to the portion of the edible substrate to which the image is applied. In other embodiments the portion of the edible substrate to which the image is not applied is excised from the portion of the substrate to which the image is applied and discarded prior to application of the edible moisture barrier.

### BRIEF DESCRIPTION OF THE DRAWINGS

FIG. 1 illustrates a full or partially full sheet 1 of sheeted edible substrate unprinted and uncoated.

FIG. 2 is a cross-section the edible sheeted material 1 shown in FIG. 1 releaseably adhered to a non-edible carrier sheet 2.

FIG. 3 illustrates the sheeted edible media 1 having been printed with edible ink to provide one or more images 3.

FIG. 4 illustrates the cross-section of the edible printed sheet and the location of printed image 3 on the surface of the edible substrate.

FIG. 5 illustrates the printed edible substrate having been cut or stamped and excess edible material removed, resulting in multiple printed edible base shapes 5 releaseably adhered to the non-edible carrier sheet 2.

FIG. 6 illustrates the cross-section of FIG. 5.

FIG. 7 illustrates a cross-section of multiple printed edible base shapes 5 and non-edible carrier sheet 2 having been coated 6 with an edible moisture (oxygen, etc.) barrier providing the described benefits of the improved edible substrate.

FIG. 8 illustrates a blank non-edible carrier sheet 2.

FIG. 9 illustrates a cross-section of the non-edible carrier sheet 2 shown in FIG. 8.

FIG. 10 illustrates multiple edible base shapes 7 having been deposited on the non-edible carrier sheet 2.

FIG. 11 illustrates a cross-section of FIG. 10 showing multiple edible base shapes 7 releaseably adhered to the non-edible carrier sheet 2.

FIG. 12 illustrates the multiple edible base shapes having been printed with edible ink providing a decorative graphic 5. Although edible base shapes 5 may be removed from the non-edible carrier sheet 2 for coating, this drawing depicts the multiple edible base shapes 5 releaseably adhered to the non-edible carrier sheet 2.

FIG. 13 illustrates a cross-section of FIG. 12.

FIG. 14 illustrates a cross-section of FIG. 12 illustrating a cross-section of multiple printed edible base shapes 5 and non-edible carrier sheet 2 having been coated 6 with an edible moisture (oxygen, etc.) barrier providing the described benefits of the improved edible substrate.

### DETAILED DESCRIPTION OF THE INVENTION

The invention relates to a composition comprising an edible substrate coated over a substantial portion of its surface with an edible moisture barrier (an “improved edible substrate”). As described herein the improved edible substrate of the invention has one or more improved functional properties relative to corresponding edible substrate in the absence of the edible moisture barrier.

Edible substrates for use in the invention will typically be any substrate suitable for having an edible image printed thereon or applied thereto. In particular embodiments the edible substrate is a significantly moisture or oxygen sensitive edible substrate. In other embodiments the edible substrate is a substrate having an edible embellishment, e.g., an edible image printed thereon, particularly substrates other than pills or candies. In particular embodiments the edible image is a moisture sensitive edible image, e.g., an edible image printed with moisture sensitive inks. In specific embodiments the edible substrate is an edible sheet-like material, e.g., an edible frosting sheet. The edible substrate can also be, for example, bubble gum.

As used herein, “edible” means safe to eat or generally recognized as safe (GRAS) by the FDA. The invention may make particular use of edible substrates which are significantly moisture sensitive, i.e., which readily gain or lose moisture to their environment. Edible substrates suitable for having an edible image printed thereon with an edible dye or edible pigment are particularly suitable for use in the invention, as such dyes and pigments are generally highly susceptible to destruction upon exposure to excess moisture. Thus application of the edible moisture barrier will provide improved stability for such images. In one embodiment the edible substrate has an edible image printed thereon with an edible dye or edible pigment. In other embodiments the edible substrate is suitable for use in embellishing a food product such as a baked good or confection (e.g., a cake, cookie, pie, cupcake, bread, brownie or bar-type confection and the like). In particular embodiments the edible substrate is not a pill or candy.

Many edible substrates are known in the art or are commercially available. For example, edible papers and edible sheet material such as edible frosting sheet material can be obtained from a number of commercial sources. For example, suitable edible substrates can be obtained from Lucks Food Decorating Company (www.Lucks.com), Gilro Ltd. (www.gilro.co.il (U-Grafix)), DecoPac Inc. (www.decopac.com), Jack Guttman Inc. Bakery Crafts® (www.bakerycrafts.com), and Kopykake Enterprises (www.KopyKake.com). In addition, a number of U.S. patents describe edible substrates and systems and methods of printing images thereon (e.g., U.S. Pat. No. 7,128,938, U.S. Pat. No. 6,652,897, U.S. Pat. No. 6,616,958, U.S. Pat. No. 6,582,742, U.S. Pat. No. 6,319,530 and U.S. Pat. No. 6,030,134). These embodiments are for illustrative purposes only and are not intended to limit the invention. Edible substrates useful in the invention may be of the preprinted or print-on-demand type.

Typically the edible substrate will have an image applied to its surface (i.e., an imaged edible substrate or imaged substrate) prior to coating with the edible moisture barrier. However there are embodiments in which the edible substrate is coated with the edible moisture barrier prior to application of an edible image; the substrate may be optionally recoated with the moisture barrier after application of the image. For example, one or more solvent based edible inks can be applied to produce an image (e.g., by ink jet printing) on the surface of an edible substrate previously coated over all or a portion of one or more surfaces with a solvent-based edible moisture barrier. The imaged substrate can optionally be further coated with the same or a different edible moisture barrier over all or a portion (e.g., the same or a different portion with respect to a prior coating application) of the surface of the substrate.

The edible substrate may be obtained in a pre-embellished (e.g., preprinted) form, i.e., obtained with the image or text already applied, or may be obtained in blank form and embellished (e.g., printed) on demand. Components, processes and systems for printing or applying images or text to an edible substrate are known in the art. The invention has particular application to images which are printed or applied using edible dyes and pigments, e.g., using inkjet technology (see, e.g., U.S. Pat. No. 7,128,938, U.S. Pat. No. 6,652,897, U.S. Pat. No. 6,616,958, U.S. Pat. No. 6,582,742, U.S. Pat. No. 6,319,530 and U.S. Pat. No. 6,030,134). For example, the applied or printed image may be one or more graphics (e.g., a drawing or photograph), text, or both one or more graphics and text. In one embodiment the embellishment applied to the edible substrate is not a traditional frosting or icing embellishment. The surface of the substrate may have additional edible embellishments applied prior to, concurrent with, or subsequent to application or printing of the image. Such embellishments may be applied across all or a portion of the edible substrate. For example, edible glitter and/or pearlescent edible mica (also known as mica-based pearlescent pigment) may be applied to the surface of the substrate (e.g., using a mask or stencil or hand held sprayer). Sprinkles, food coloring, and icing/frosting may also be applied to the edible substrate. In addition, the portion of the edible substrate to which the image has been applied may be excised from the remainder of the edible substrate prior to or subsequent to coating (e.g., the image-bearing portion of an edible frosting sheet may be cut from the non-image-bearing portion of the sheet or vice versa).

The edible substrate is coated to cover a substantial portion of one or more surfaces with an edible moisture barrier. As used herein, “a substantial portion” of the edible substrate surface is intended to mean coverage of a portion of the substrate sufficient to provide one or more of the improved properties associated with the invention. The moisture barrier can be applied to the entire surface of the edible substrate (e.g., both to areas of the substrate on which an image is applied and to blank areas) or to only a portion of the surface. For example, the edible moisture barrier may be applied only to the area of the substrate on which an image has been printed. The edible moisture barrier may be applied continuously across a surface of the edible substrate, or it may be applied in a non-continuous pattern (e.g., stippled or concentric geometric patterns) or it can be applied randomly. In addition, for flat or sheet-like edible substrates, the edible moisture barrier may be applied to the front and/or the back of the substrate in accordance with the invention. The amount of edible substrate surface covered and/or the pattern of coverage is not critical to the invention, so long as the coverage is sufficient to provide one or more of the improved properties associated with the invention.

In addition, multiple applications of edible moisture barrier may be used. Each application may utilize the same or different edible moisture barrier as one or more of the prior applications of the moisture barrier. Each application may also cover the same, different, overlapping or non-overlapping areas of the substrate as one or more prior applications. In addition, embellishment may be added to the edible substrate before or after any application of moisture barrier. For example, a blank (unimaged) edible substrate may be coated with one or more applications of edible moisture barrier according to the invention. As another example, a blank edible substrate can have an image applied thereto, and subsequently have one or more applications of the same or different moisture barrier applied. As yet another example, one or more applications of the same or different edible moisture barrier can be applied to an edible substrate prior to application of an image, and one or more applications of the same or different edible moisture barrier can optionally be applied to the substrate after it is imaged. Optionally a further image or embellishment can then be applied, with or without further applications of moisture barrier. For example, an imaged edible substrate can be coated with one or more moisture barriers and then an edible glitter or pearlescent mica can be applied, and the resulting product can have one or more further applications of edible moisture barrier applied. Typically with each additional application of moisture barrier the substrate will become less pliable and more rigid or vinyl-like.

Suitable edible moisture barriers for use in the invention are known in the art and available commercially. In some embodiments the edible moisture barrier will be comprised of a hydrophobic material. In particular embodiments the moisture barrier can comprise a hydrophobic protein material such as corn zein, wheat protein, soy protein, egg albumin, or whey protein. In other embodiments the edible moisture barrier can comprise a carbohydrate polymer such as cellulose (e.g., carboxymethylcellulose and hydroxypropyl cellulose), starch, dextrins, pectin (e.g., pectin emulsions) and alginates. The edible moisture barrier can also comprise a solid lipid/wax (e.g., beeswax, carnuba wax, etc.) or a resin (e.g., edible shellac, edible shellac/oil combinations). Other non-limiting examples of useful moisture barriers include emulsions of palmitic acid, gelatin, collagen, and the like.

The edible moisture barrier will typically be formulated in an edible carrier for application to the edible substrate. However inedible carriers may be used as appropriate; for example, an inedible carrier which evaporates completely (e.g., IPA) may also used in certain circumstances. The carrier will generally be water-based or solvent-based (e.g., alcohol such as ethanol, isopropyl alcohol or Specially Denatured alcohol), with solvent-based or significantly solvent-based being preferred. The amount of liquid carrier in the moisture barrier formulation is controlled to avoid disrupting the image and/or transferring moisture to (e.g., dissolving) either the edible dyes or pigments or the edible substrate itself. Solvent-based carriers are thus preferred due to their preferred evaporative properties.

In a preferred embodiment the edible moisture barrier is formulated such that it does not dry too quickly upon application (i.e., is able to be applied in a continuous coating rather than producing a mottled or spotted coating) but also dries to a tacky finish preferably in a minute or less (i.e., once applied does not remain wet for a time period sufficient to negatively impact the substrate or image properties).

The skilled artisan will appreciate that both formulation and application method and conditions (e.g., spray gun properties, distance from substrate, ambient temperature, etc.) can be varied to achieve an appropriate effect. For example, for a significantly solvent-based carrier (e.g., an alcohol carrier), the formulation can, in some embodiments, comprise from about 1% to about 40% solids, preferably from 5% to about 37% solids, and more preferably from about 10% to about 30% solids. It will be apparent that in circumstances where multiple applications of edible moisture barrier are used, the solids content will accumulate additively; that is, three separate applications of a moisture barrier each of which comprises 10% solids will result in an accumulation of approximately 30% solids on the substrate. Moreover, the water content of a significantly solvent-based carrier formulation can be adjusted to control evaporative properties of the formulation. For example, in some embodiments the water content of the formulation will be less than 30%, preferably less than about 25%, and more preferably less than about 20%.

A number of suitably formulated edible moisture barriers are available commercially. For example, Freeman Industries LLC (www.freemanllc.com) sells a number of zein and similar products suitable for use in the invention. Similarly Centerchem, Inc. (www.centerchem.com) has a number of suitable edible moisture barrier products available, including Capol®150.

The edible moisture barrier formulation can be applied to the edible substrate in any suitable manner consistent with the pattern of application desired and the type and properties of the edible substrate. For example, the edible moisture barrier formulation can be sprayed, painted, stamped, rolled or dragged onto the substrate or a carrier-type release media holding the edible substrate (i.e., to which the substrate is releaseably adhered). The application of moisture barrier as described herein can occur while the edible substrate is adhered to an inedible carrier or not adhered to a carrier. The substrate or carrier may be dipped in the moisture barrier formulation. Although the edible moisture barrier will preferably be applied to the substrate before it is applied to a food product, it is also contemplated that the coating may be applied or reapplied to the substrate after it is applied to a food product.

Additional optional components may also be utilized with the edible substrate to improve its functional properties. For example, plasticizers, glycerine, preservatives and the like may be applied. These optional components can be applied separately but are most preferably admixed with the moisture barrier such that all of the components are co-applied to the edible substrate. Edible glitter and/or pearlescent edible mica, food coloring and similar components may also be applied separately or admixed with the moisture barrier for application to the edible substrate. In one embodiment a hand held sprayer (sand blasting type) can be used to dry spray edible glitter or mica-based pearlescent pigments to the still-wet coating to add additional embellishment. The substrate and/or image can optionally be recoated over all or a portion of its surface after application of the further embellishment.

Improved edible substrates of the invention can be prepared by processes described herein and other processes known to the skilled artisan. Generally, an imaged or unimaged, embellished or unembellished edible substrate (e.g., an edible substrate sheet or multiple edible base-shaped substrates deposited on an inedible carrier) according to the invention is obtained, and an edible moisture barrier is applied thereto.

A large number of permutations of the process are contemplated. The only critical step in the process is the application of edible moisture barrier to the substrate. The moisture barrier may be applied to an imaged or unimaged edible substrate in its intact state, i.e., applied to the substrate without further modification of the substrate. In other embodiments predetermined shapes of the imaged or unimaged substrate may be excised from excess substrate, or the excess substrate may be excised from predetermined shapes of the imaged or unimaged substrate. Excision can take place prior to or subsequent to the application of the edible moisture barrier. Alternatively the imaged or unimaged substrate may be modified with additional embellishment (e.g., with additional image(s), edible glitter, edible food coloring, edible mica) prior to application of the moisture barrier.

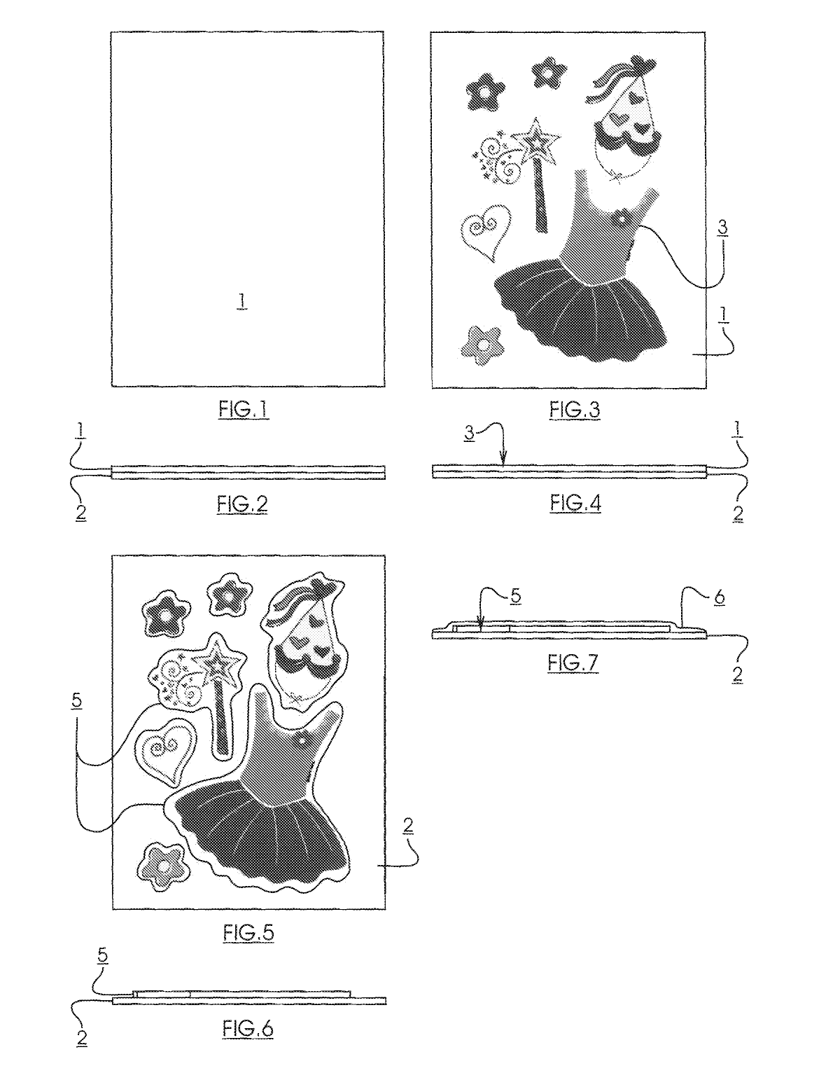

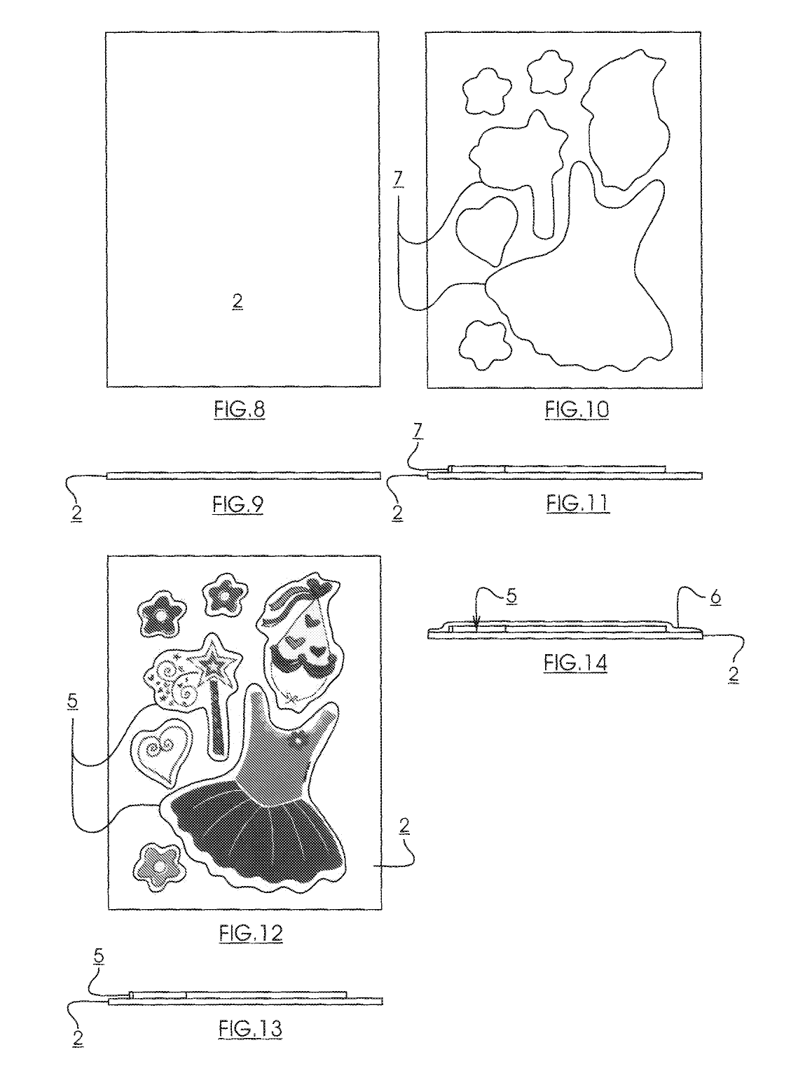

In a preferred embodiment, the excess (non-imaged) substrate is excised from the non-imaged substrate on the carrier sheet (see, for example, FIG. 1 to FIG. 7). This can produce images with a sticker-like appearance (i.e., one or more distinct images with discrete and distinct margins/borders), essentially resulting in edible stickers. The excision can be performed using any excision method, including, but not limited to, die cutting (e.g., steel rule die, roll die, etc.), stamping, knife or blade, digital vinyl cutter, etc.). In particularly preferred embodiments the excision takes place prior to at least one application of the moisture barrier. The application of the moisture barrier to the excised imaged substrate facilitates an improved adherence of the substrate pieces to the carrier by creating a flexible film across the surface of the imaged substrate pieces and the exposed carrier. In another embodiment individual or multiple edible base shapes are formed (deposited) onto a non-edible carrier sheet first, then subsequently printed and coated (see, for example, FIG. 8 to FIG. 14).

FIG. 1 through FIG. 7 incrementally illustrate the process by which a full blank (un-printed, un-coated) sheet of edible media is first printed, cut, then coated. FIG. 8 through FIG. 14 incrementally illustrate the process by which individual or multiple edible base shapes are formed (deposited) onto a non-edible carrier sheet first, then subsequently printed and coated. This process of individual or multiple depositing of edible base shapes would potentially eliminate the cutting (or stamping) process to separate desired product from excess material. Both processes are preferred embodiments of the invention.

The improved edible substrate of the invention can be prepared or manufactured and then used immediately or can be packaged for wholesale or retail sale. The one or more beneficial properties of the improved edible substrate allow for packaging options that were previously foreclosed as a result of the moisture and oxygen sensitivity of certain substrates and embellishments. For example, the improved edible substrate can be packaged in a clear or translucent plastic package, allowing the consumer to see the product inside the package and eliminating the need for expensive graphic labeling.

The improved edible substrate can also be prepared and utilized in the print-on-demand market. In this context the edible image is applied to the edible substrate on demand as appropriate, and the resulting imaged substrate is coated with the edible moisture barrier over a substantial portion of its surface. Thus the application of the moisture barrier can be performed, for example, by bakery personnel such as in a store or an on-line service provider. It is contemplated that both the application of an image or other embellishment to the substrate and the application of the coating can be performed by the same person or entity (e.g., within the same bakery). It is also contemplated that the application of an image to the substrate and the application of the coating can be performed by distinct persons or entities. For example, an uncoated edible substrate having an image applied thereto can be purchased or obtained from a source and subsequently coated over a substantial portion of its surface with an edible moisture barrier. It is also contemplated that blank edible substrates can be coated in accordance with the invention and transferred (e.g., by wholesale or retail sale), and then embellished (imaged) and optionally recoated after transfer.

The invention provides an edible substrate e.g., an edible substrate having an image printed thereon, having improved properties. In particular embodiments, the invention relates to an edible substrate having improved moisture stability, i.e., tolerance to a range of high and low humidity conditions. In particular embodiments the improved edible substrate may also have improved resistance to the damaging effects of oxygen. In certain embodiments the improved edible substrate may have improved shelf life, particularly in extreme conditions. Particularly for edible sheet-type substrates, the invention will reduce the tendency of the substrate to lose moisture to the ambient atmosphere and become brittle and unusable. The invention will also reduce the tendency of these types of substrates to take on moisture from the ambient atmosphere and become tacky and difficult to remove from the carrier.

The improved edible substrate may also have a glossy surface appearance, resulting in altered visual appeal (images printed on the edible substrate may appear brighter, sharper and have improved color and clarity, i.e., the image appears to “pop”). The improved edible substrate may, of course, also be prepared to have a flat matte sheen. In addition, the invention may have particularly beneficial application to edible substrates having an image printed thereon with edible dyes and pigments, as these dyes and pigments are particularly moisture, oxygen and UV light sensitive. The application of the moisture barrier may tend to reduce these sensitivities and to protect the image from the damaging effects of these factors.

The improved edible substrate may also have improved UV light resistance and/or improved light reflecting properties, as well as reduced fading and discoloration of the substrate and of images printed thereon. In other embodiments the improved edible substrate may have improved adherence to a carrier upon which it is deposited, for example, during the manufacturing process. The improved edible substrate may also have improved flexibility (i.e., can be flexed to a reasonable degree without cracking). The improved functionality of the edible substrate of the invention allows products incorporating the substrate to be packaged in simple, economical, clear packaging and may improve retail acceptance of these products. The improved edible substrate need not have all of the improved properties in the context of the invention but will typically have at least one improved property.

Improved edible substrates of the invention can be used to embellish many types of food products. As non-limiting examples, a food product such as a baked good or confection (e.g., a cake, cookie, pie, cupcake, bread, brownie or bar-type confection and the like) can be embellished with the improved edible substrates. Typically the food product will be a frosted or iced product, i.e., have a frosted or iced portion, and generally the improved edible substrate will be applied or affixed to the food product in the iced or frosted area.

The invention will be further illustrated by the following non-limiting examples. The teachings of all references and websites cited herein are incorporated by reference.

### EXAMPLES

### Preparation of Improved Edible Substrate

A highly soluble edible substrate contained on a carrier sheet (U-Graphix Edible Frosting Sheet, Gilro Ltd.) had an image printed thereon with edible inks using inkjet technology, producing a brilliant image of high resolution and color gamut. The image(s) were then kiss cut while the edible substrate remained on the carrier sheet, and the excess (unprinted) material was removed.

An edible moisture barrier comprising edible shellac and vegetable oil (coconut origin) in an ethanol carrier was obtained from a commercial source (Capol® 150, Centerchem, Inc.) and was applied by fine spray directly on the remaining printed edible substrate and carrier sheet, covering the printed area. The sprayed area became tacky to the touch almost immediately, and the coating was allowed to dry thoroughly. The coating acts to seal the edge of the edible portion to the carrier sheet, effecting a better continuous barrier and improving adherence of the images to the carrier sheet. Without the moisture barrier the images, particularly smaller images, typically lack sufficient adherence to the carrier sheet. The resulting printed edible substrate contained on the carrier sheet and having a moisture barrier applied thereto is then packaged in a clear plastic bag for retail sale.

In general the uncoated material became useless when exposed to less than 28% or greater than 65% humidity for more than one hour. The coated material, however, never lost adhesion or flexibility, nor became too moist so as to not release from the inedible carrier at these levels at any length of time.

### Preparation of Embellished Improved Edible Substrate

Embellished improved edible substrates of the invention can be prepared by a variety of methods, non-limiting examples of which are provided below.

Option 1) Print edible substrate with edible inks and perform die cutting operation. Remove excess edible substrate exposing edible “sticker” style shapes remaining adhered to the carrier sheet. Spray apply coating that has edible glitter or pearlescent mica added to it in sufficient quantity so as to impart a glitter or shimmer decoration to the printed image when dry. This option applies glitter and or shimmer decoration to entire surface of imaged edible substrate and carrier sheet.

Option 2) Print edible substrate with edible inks and perform die cutting operation; do not remove excess edible substrate. This leaves the printed and cut edible substrate complete on the carrier sheet. Spray apply coating that has edible glitter or pearlescent mica added to it in sufficient quantity so as to impart a glitter or shimmer decoration on the printed image when dry. The excess edible substrate is then removed from the carrier sheet, exposing the imaged edible substrate (e.g., “stickers”) that now have an additional glitter or shimmer imparted. One or more additional clear coatings may then be applied to entire surface of cut (exposed) edible stickers and carrier sheet, effectively improving the adhesion to the carrier backing as earlier described.

Option 3) Print edible substrate with edible inks and perform die cutting operation; remove or do not remove the excess edible media. Apply a die cut-type mask over the edible media. Spray apply coating that has edible glitter or pearlescent mica added to it in sufficient quantity so as to impart a glitter or shimmer decoration on or near the printed image when dry. The excess edible material may now be removed or not from the carrier. The mask provides selective placement of the glitter or shimmer.

Option 4) Print, cut, spray and sprinkle or otherwise apply the described decorative materials to the still wet coating. The coating will dry and adhere the edible glitter or pearlescent mica to the image. Strip excess edible material if desired.

What is claimed is:

1. A composition comprising a moisture and/or oxygen sensitive edible substrate coated over a substantial portion of one or more surfaces with at least one edible moisture barrier.

2. A composition according to claim 1 wherein the edible substrate is a substrate suitable for having an edible image applied thereto.

3. A composition according to claim 1 wherein the edible substrate has an edible embellishment applied thereto.

4. A composition according to claim 1 wherein the edible substrate has an edible image applied thereto.

5. A composition according to claim 2 or 4 wherein the edible image is a moisture and/or oxygen sensitive image.

6. A composition according to claim 1 wherein the edible substrate is not a pill or a candy.

7. A composition according to claim 1 wherein the edible substrate is an edible paper, an edible sheet or an edible frosting sheet.

8. A composition according to claim 4 wherein the edible image is printed with edible dye, edible pigment or both.

9. A composition according to claim 1 wherein the edible substrate is coated over one or more entire surface with said edible moisture barrier.

10. A composition according to claim 4 wherein only the portion of the edible substrate having said image applied thereon is coated with said edible moisture barrier.

11. A composition according to claim 1 wherein the edible moisture barrier comprises a hydrophobic material.

12. A composition according to claim 1 wherein the edible moisture barrier comprises a hydrophobic protein material.

13. A composition according to claim 1 wherein the edible moisture barrier is selected from the group consisting of corn zein, wheat protein, soy protein, egg albumin, and whey protein.

14. A composition according to claim 1 wherein the edible moisture barrier comprises a carbohydrate polymer.

15. A composition according to claim 1 wherein the edible moisture barrier comprises a cellulose, a starch, a dextrin, a pectin, an alginate, or combinations thereof.

16. A composition according to claim 1 wherein the edible moisture barrier comprises carboxymethylcellulose, hydroxypropyl cellulose, or combinations thereof.

17. A composition according to claim 1 wherein the edible moisture barrier comprises a solid lipid or wax.

18. A composition according to claim 1 wherein the edible moisture barrier comprises beeswax, carnuba wax or combinations thereof.

19. A composition according to claim 1 wherein the edible moisture barrier comprises an edible resin.

20. A composition according to claim 1 wherein the edible moisture barrier comprises an edible shellac or an edible shellac/oil combination.

21. A composition according to claim 1 wherein the edible moisture barrier comprises an emulsion of palmitic acid, gelatin, collagen or combinations thereof.

22. A composition according to claim 1 wherein the edible substrate further optionally comprises one or more plasticizers, glycerines, preservatives, edible glitter, pearlescent edible mica or combinations thereof.

23. A food product embellished with a composition comprising an edible substrate coated over a substantial portion of one or more surfaces with at least one edible moisture barrier.

24. A method of preparing a composition comprising an edible substrate coated over a substantial portion of one or more surfaces with at least one edible moisture barrier, said method comprising:
obtaining an edible substrate selected from the group consisting of an unimaged edible substrate, an imaged edible substrate, an embellished edible substrate and an unembellished edible substrate; and
applying at least one edible moisture barrier over a substantial portion of one or more surfaces of the edible substrate.

25. A method according to claim 24 wherein the edible substrate is an imaged edible substrate and wherein the edible moisture barrier is applied at least to the portion of the edible substrate to which the image is applied.

26. A method according to claim 24, further comprising excising desired portions of the edible substrate from undesired portions of the edible substrate.

27. A method according to claim 24, further comprising excising undesired portions of the edible substrate from desired portions of the edible substrate.

28. A method according to claim 24 wherein the step of applying at least one edible moisture barrier over a substantial portion of one or more surfaces of the edible substrate is repeated one or more times.

29. A method according to claim 24 further comprising applying one or more embellishments to said edible substrate prior to or subsequent to the step of applying at least one edible moisture barrier.

30. A method according to claim 29 wherein said one or more embellishments comprises one or more edible images.

31. A method of preparing a composition comprising an edible substrate coated over a substantial portion of one or more surfaces with at least one edible moisture barrier, said method comprising:
obtaining an edible substrate;
applying an edible embellishment thereto;
applying at least one edible moisture barrier over a substantial portion of one or more surfaces of the edible substrate; and
optionally repeating one or more times either or both of the steps of applying at least one edible moisture barrier over a substantial portion of one or more surfaces of the edible substrate and applying an edible embellishment to said edible substrate.

32. The method according to claim 31 wherein the edible embellishment is an edible image.

33. A method of preparing a composition comprising an edible substrate coated over a substantial portion of one or more surfaces with at least one edible moisture barrier, said method comprising:
obtaining an edible substrate;
applying at least one edible moisture barrier over a substantial portion of one or more surfaces of the edible substrate;
applying an edible embellishment to said edible substrate; and
optionally repeating one or more times either or both of the steps of applying at least one edible moisture barrier over a substantial portion of one or more surfaces of the edible substrate and applying an edible embellishment to said edible substrate.

34. The method according to claim 33 wherein the edible embellishment is an edible image.
